(19) United States
(12) Patent Application Publication
(10) Pub. No.: US 2008/0246370 A1
(43) Pub. Date: Oct. 9, 2008

(54) Actuator for the Drive Train of a Motor Vehicle

(75) Inventor: Frank-Detlef Speck, Langenargen (DE)

Correspondence Address: DAVIS BUJOLD & Daniels, P.L.L.C., 112 PLEASANT STREET, CONCORD, NH, 03301, US

(73) Assignee: ZF FRIEDRICHSHAFEN AG, Friedrichshafen (DE)

(21) Appl. No.: 11/660,708

(22) PCT Filed: Jul. 5, 2005
(86) PCT No.: PCT/EP05/07232

§ 371 Date: Apr. 11, 2007

(30) Foreign Application Priority Data
Aug. 21, 2004 (DE) 10 2004 040586.7

(51) Int. Cl. H02N 2/04

(52) U.S. Cl. 310/328

(57) ABSTRACT

An actuator for the drive train of a motor vehicle for the automation of a manual gearbox. The invention is characterized in that the actuator is produced from an electrostrictive material.

This application is a national stage completion of PCT/EP2005/007232 filed Jul. 5, 2005, which claims priority from German Application Serial No. 10 2004 040 586.7 filed Aug. 21, 2004.

### FIELD OF THE INVENTION

The present invention concerns an actuator for the drive train of a motor vehicle, in particular for the automation of a transmission.

### BACKGROUND OF THE INVENTION

The automation of transmission functions is becoming increasingly important. Automated transmissions that display this kind of automation have the advantage of relieving the driver of the vehicle of the need to change gears.

On the whole, this makes greater comfort and safer operation possible. In addition, automated transmissions show significant cost advantages. According to the state of the art, actuating the clutch normally involves a translation movement being transferred by way release bearing of the clutch. Similar designs are also used for transmission automation in which case two kinematically independent motions are necessary for selecting and shifting. According to the state of the art, these motions normally are performed by electromechanical gear actuators.

Different electromechanical actuators are known from the state of the art. They are configured either with self-impeding worm gears and linear compensation or, as the case may be, with large helical gear translation and non-linear compensation.

These designs are disadvantageously elaborate, as transmissions are needed, for example, for the conversion of rotatory into translatory motion, which require a relatively large amount of space for installation.

### SUMMARY OF THE INVENTION

The present invention is based on the task of providing actuators for the drive train of a motor vehicle, in particular for the automation of a transmission, which does not display the disadvantages of the actuators known from the state of the art, as described above. In particular, the actuators should require little space for installation and be simple in construction, while the use of transmissions for motion transformation should be avoided.

### DETAILED DESCRIPTION OF THE INVENTION

It is proposed that the actuators required in the drive train of a motor vehicle, in particular those that are required for the automation of a transmission, be produced from an electrostrictive material.

In the case of electrostrictive materials, the geometry is modified depending on an electrical field applied to the material, elongation being proportional to the square of the locally applied field in the crystal structure. According to the invention, this characteristic is to be used to realize the automation of a transmission.

In order to produce a live axle for an actuating motion, the invention requires only a block or rod made from a suitable electrostrictive material as an actuator to which a voltage can be applied. Depending on the voltage applied, a linear motion is produced by way of a uniaxial elongation or contraction without the necessity of employing additional gears, which has the advantage of enabling continuous motion.

Additionally, the invention allows for one non-fixed, and thus maneuverable end of the block/rod to act directly on the control element that is supposed to be actuated, such as gear retractors, control rods, shift rails, clutch release levers, etc.

Electrostrictive actuators are characterized by particularly high energy density so that the actuators, according to the invention, can be arranged directly at the desired site of installation. For example, the actuator for clutch automation can be configured as a ring-shaped central shifter that acts directly on the release bearing of the clutch. A rod or block-shaped actuator made of an electrostrictive material can advantageously act directly on the sliding collar for the purpose of transmission automation.

The actuators are advantageously made of electrostrictive polymers that display very good electrostrictive traits.

In connection with a particularly advantageous further embodiment of the invention, it is proposed that the actuators, made from an electrostrictive material, are simultaneously used as sensors, which eliminates the need to install additional position sensors.

The conceptual design of the invention enables the realization of the automation of a transmission in a simple manner and with little space needed for installation. Furthermore, the actuators can replace existing conventional actuators found in the drive train of a motor vehicle.

1-7. (canceled)

8. An actuator for a drive train of a motor vehicle for automation of a transmission, the actuator being made of an electrostrictive material.

9. The actuator for the drive train of the motor vehicle according to claim 8, wherein the actuator is made of an electrostrictive polymer.

10. The actuator for the drive train of the motor vehicle according to claim 8, wherein the actuator is one of a block and a rod which produces a live axle, to which a voltage is applied.

11. The actuator for the drive train of the motor vehicle according to claim 10, wherein a non-fixed and therefore maneuverable end of one of the block and the rod, communicates directly with a control element being actuated.

12. The actuator for the drive train of the motor vehicle according to claim 11, wherein the actuator for automation of a clutch is a ring-shaped central shifter which operates directly with a release bearing of the clutch.

13. The actuator for the drive train of the motor vehicle according to claim 11, wherein the actuator for automation of a clutch operates directly on a sliding collar to be actuated.

14. An actuator for a drive train of a motor vehicle for automation of a transmission, the actuator is made of an electrostrictive material and senses a position of a control element being actuated.

15. An actuator for a drive train of a motor vehicle, for automation of a transmission, and the actuator being provided for one of engaging and disengaging a first component with a second component;
wherein the actuator at least partially includes an electrostrictive material and is a ring-shaped central shifter;
the actuator directly operates with a release bearing of a clutch and moves linearly upon application of an electrical force thereto.
